(19) United States
(12) Patent Application Publication
(10) Pub. No.: US 2024/0020578 A1
(43) Pub. Date: Jan. 18, 2024

(54) METHOD FOR EMBEDDING DATA AND SYSTEM THEREOF

(71) Applicant: SAMSUNG SDS CO., LTD., Seoul (KR)

(72) Inventors: Hyun Jae LEE, Seoul (KR); Hyun Jin CHOI, Seoul (KR); Jae Woong YUN, Seoul (KR)

(73) Assignee: SAMSUNG SDS CO., LTD., Seoul (KR)

(21) Appl. No.: 18/221,742

(22) Filed: Jul. 13, 2023

(30) Foreign Application Priority Data
Jul. 14, 2022 (KR) 10-2022-0086755
Oct. 31, 2022 (KR) 10-2022-0142761

(51) Int. Cl. G06N 20/00

(52) U.S. Cl. CPC G06N 20/00

(57) ABSTRACT

Methods and apparatuses for embedding data. The method for embedding data includes: acquiring a pretrained embedding model; generating a prompt associated with a data sample through a prompt encoder, the prompt encoder being lighter than the embedding model; generating an embedding representation of the data sample by inputting the prompt and the data sample to the embedding model; calculating a task loss by performing a predefined task by using the embedding representation; and updating the prompt encoder based on the task loss.

### CROSS-REFERENCE TO RELATED APPLICATION(S)

This application claims priority from Korean Patent Application No. 10-2022-0086755 filed on Jul. 14, 2022 and Korean Patent Application No. 10-2022-0142761 filed on Oct. 31, 2022 in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for embedding data and a system thereof, and more particularly, to a method for embedding data of various types/formats such as text and image, and a system for performing the method.

### Description of the Related Art

Since performance of an embedding model is directly associated with performance of a target task, the embedding model is typically designed at a large scale and learned using a large amount of training set. For example, a model for embedding a text such as a natural language sentence may be designed to have one or more learnable parameters.

Meanwhile, to reduce a learning cost of the embedding model, a pretrained embedding model (e.g., BERT, RoBERTa, etc.) may be used. For example, an embedding model of an inference step may be constructed by fine-tuning the pretrained embedding model using an appropriate training set. However, due to the large scale of the embedding model, a significant learning cost is required even for fine-tuning the model.

### SUMMARY

An object of the present disclosure is to provide a method for embedding data to reduce a leaning cost of an embedding model and a system for performing the method.

Another object of the present disclosure is to provide a method for embedding data to improve embedding performance while reducing a leaning cost, and a system for performing the method.

Other object of the present disclosure is to provide a method for learning embedding, which is applicable to data of various types/formats.

The objects of the present disclosure are not limited to those mentioned above and additional objects of the present disclosure, which are not mentioned herein, will be clearly understood by those skilled in the art from the following description of the present disclosure.

According to an aspect of the inventive concept, there may be provided a method for embedding data, the method being performed by at least one computing device and including: acquiring a pretrained embedding model; generating a prompt associated with a data sample through a prompt encoder, the prompt encoder being lighter than the embedding model; generating an embedding representation of the data sample by inputting the prompt and the data sample to the embedding model; calculating a task loss by performing a predefined task by using the embedding representation; and updating the prompt encoder based on the task loss.

In some embodiments, the updating the prompt encoder may include updating the prompt encoder in a state of freezing the embedding model.

In some embodiments, the generated prompt may include a first prompt and a second prompt, and the first prompt and the second prompt may be input to different layers of the embedding model.

In some embodiments, the data sample may be a text sample, the embedding model may be a model for further receiving a special token in addition to tokens included in the text sample, and the generated prompt may be reflected in an internal embedding representation of the embedding model associated with the special token.

In some embodiments, the generating the embedding representation may include replacing the internal embedding representation associated with the special token with the generated prompt to generate the embedding representation.

In some embodiments, the task loss and the embedding representation may be a first task loss and a first embedding representation, respectively, and the method may further include: generating a transformed data sample for the data sample; generating a second embedding representation by inputting the transformed data sample to an auxiliary embedding model; calculating a second task loss by performing a transformation determination task or a transformation detection task based on the second embedding representation; and updating an associated prompt encoder based on the second task loss.

In some embodiments, the auxiliary embedding model may be configured to generate the second embedding representation by further receiving the first embedding representation.

In some embodiments, the auxiliary embedding model may be configured to generate the second embedding representation by receiving only the transformed data sample and the first embedding representation.

In some embodiments, the transformation determination task or the transformation detection task may be performed through a task module, and the task module may be updated based on the second task loss.

In some embodiments, the prompt encoder and the prompt may be a first prompt encoder and a first prompt, respectively; the second embedding representation may be generated by inputting a second prompt associated with the transformed data sample to the auxiliary embedding model; the second prompt may be generated through a second prompt encoder; and the associated prompt encoder may include the second prompt encoder.

In some embodiments, the second prompt encoder and the first prompt encoder may be configured to share at least some weight parameters.

In some embodiments, the auxiliary embedding model may be a pretrained model, and the updating the associated prompt encoder may include updating the associated prompt encoder in a state that the auxiliary embedding model is freezing.

In some embodiments, the data sample may be an image sample, and the generating the transformed data sample may include dividing the image sample into a plurality of patches and transforming at least a portion of the plurality of patches.

In some embodiments, the task loss and the embedding representation may be a first task loss and a first embedding representation, respectively, the data sample may be an anchor sample or a transformed sample for the anchor sample, and the method may further include: acquiring another data sample paired with the anchor sample, the another data sample being a positive sample or a negative sample for the anchor sample; generating a transformed data sample for the another data sample; generating a second embedding representation by inputting the first embedding representation and the transformed data sample to an auxiliary embedding model; calculating a second task loss by performing a transformation determination task or a transformation detection task based on the second embedding representation; and updating an associated prompt encoder based on the second task loss.

In some embodiments, the data sample and the embedding representation may be a first data sample and a first embedding representation, respectively, and the method may further include: acquiring second data sample; generating a prompt associated with the second data sample through the updated prompt encoder; and generating a second embedding representation by inputting the prompt associated with the second data sample and the second data sample to the embedding model.

According to another an aspect of the inventive concept, there is provided a system including a memory configured to store one or more instructions; and one or more processors configured to execute the stored one or more instructions to perform: acquiring a pretrained embedding model; generating a prompt associated with a data sample through a prompt encoder, the prompt encoder being lighter than the embedding model; generating an embedding representation of the data sample by inputting the prompt and the data sample to the embedding model; calculating a task loss by performing a predefined task by using the embedding representation; and updating the prompt encoder based on the task loss.

In some embodiments, the updating the prompt encoder may include updating the prompt encoder in a state of freezing the embedding model.

In some embodiments, the generated prompt may include a first prompt and a second prompt, and the first prompt and the second prompt may be input to different layers of the embedding model.

In some embodiments, the data sample may be a text sample, the embedding model may be a model for further receiving a special token in addition to tokens included in the text sample, and the generated prompt may be reflected in an internal embedding representation of the embedding model associated with the special token.

According to still another an aspect of the inventive concept, there may be provided a non-transitory computer-readable recording medium storing computer program executable by at least one processor to perform: acquiring a pretrained embedding model; generating a prompt associated with a data sample through a prompt encoder, the prompt encoder being lighter than the embedding model; generating an embedding representation of the data sample by inputting the prompt and the data sample to the embedding model; calculating a task loss by performing a predefined task by using the embedding representation; and updating the prompt encoder based on the task loss.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary schematic view illustrating a data embedding system according to some embodiments of the present disclosure;

FIGS. 2 and 3 are exemplary views illustrating a reduction effect of a learning cost of a method for embedding data according to some embodiments of the present disclosure;

FIG. 4 is an exemplary flow chart illustrating a method for embedding data according to some embodiments of the present disclosure;

FIG. 5 is an exemplary view illustrating a method for embedding data according to some embodiments of the present disclosure;

FIG. 6 is an exemplary view illustrating a data embedding process in an inference step according to some embodiments of the present disclosure;

FIGS. 7 to 9 are exemplary views illustrating a method for providing a prompt according to various embodiments of the present disclosure;

FIGS. 10 and 11 are exemplary views illustrating a process of performing a contrastive learning task according to various embodiments of the present disclosure;

FIG. 12 is an exemplary flow chart illustrating a method for embedding data according to some other embodiments of the present disclosure;

FIG. 13 is an exemplary view additionally illustrating a method for embedding data according to some other embodiments of the present disclosure;

FIG. 14 is an exemplary view illustrating a method for providing an embedding representation according to some embodiments of the present disclosure;

FIGS. 15 and 16 are exemplary views illustrating a process of performing a transformed token detection task according to various embodiments of the present disclosure;

FIGS. 17 to 19 are exemplary views illustrating a model architecture according to various embodiments of the present disclosure;

FIGS. 20 and 21 are exemplary views illustrating an embedding learning process for an image sample according to some embodiments of the present disclosure; and

FIG. 22 illustrates an exemplary computing device capable of implementing a data embedding system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will be defined by the appended claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings:

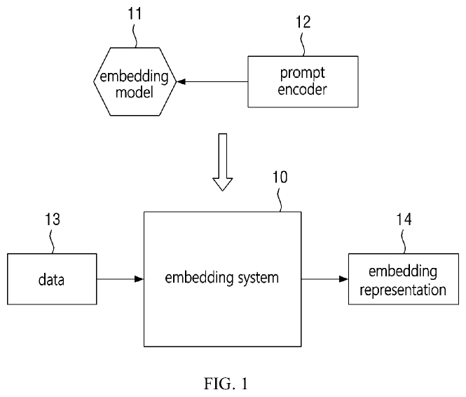

FIG. 1 is an exemplary schematic view illustrating a data embedding system 10 according to some embodiments of the present disclosure.

As shown in FIG. 1, the data embedding system 10 may be a system that generates an embedding representation 14 for a data sample 13 input through an embedding model 11. Hereinafter, for convenience of description, the data embedding system 10 is abbreviated as an ‘embedding system’ 10. In FIG. 1, the data embedding system 10 is shown as an ‘embedding system’.

For reference, the embedding representation may mean a data representation on an embedding space or a latent space. A specific data sample may be converted into a representation in the embedding space through the embedding model 11, and since the embedding representation usually has a vector format, the embedding representation may be used interchangeably with the term ‘embedding vector’ in some cases. Alternatively, the embedding representation may be used interchangeably with the term ‘embedding code’.

Also, a data sample or a sample may mean individual data constituting a data set, and may be used interchangeably with terms such as example, instance, and observation in the art.

In detail, the embedding system 10 may perform embedding learning by using a pretrained embedding model 11 and a prompt encoder 12. In this case, the prompt encoder is a lightweight model (e.g., a neural network having a smaller number of learnable parameters than the embedding model 11) for generating a prompt, and may be understood as a model introduced to reduce the cost of a learning step. In addition, the prompt may be understood as a value for adjusting a hint (e.g., small amount of information) provided (injected) to the embedding model 11 or an output value (e.g., embedding representation) of the embedding model 11 in a more accurate form.

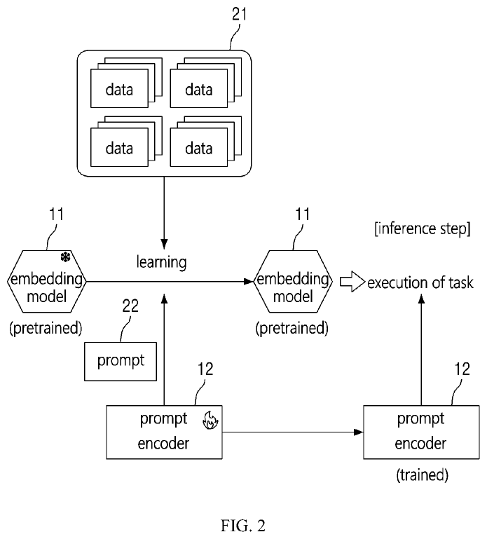

In detail, as shown in FIG. 2, the embedding system 10 may perform embedding learning by learning (updating) the prompt encoder 12 instead of the pretrained embedding model 11. That is, while embedding learning is in progress by using a training set 21, the embedding model 11 may be in a freezing state, and an output value (i.e., embedding representation) of the embedding model 11 may be gradually adjusted through the prompt 22.

In the above case, since a direct update (e.g., fine-tuning) for the embedding model 11 of a large scale is not performed in the learning step, learning costs may be significantly reduced.

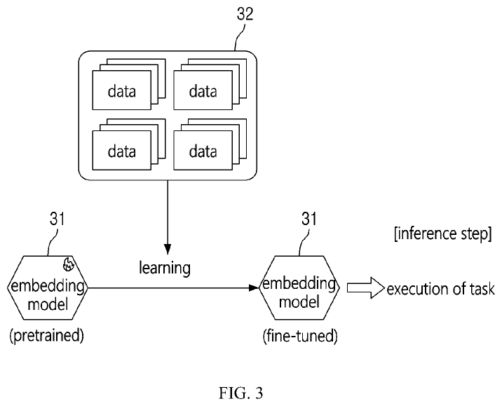

Unlike the above case, it is assumed that fine-tuning is performed for the embedding model 31 pretrained in the learning step, as shown in FIG. 3. In this case, since a direct update (that is, update on weight parameters) is performed for the embedding model 31 of the large scale by using a training set 32, a significant cost is inevitably spent on the learning step even though the pretrained embedding model 31 is given.

For reference, a snowflake mark of FIG. 2 means that the weight parameter of the embedding model 11 is not updated (i.e., the model is in a freezing state), and a flame mark of FIG. 3 means that the weight parameter of the embedding model 31 is updated.

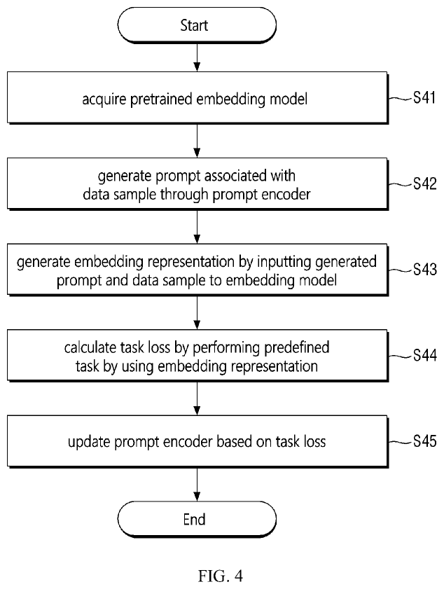

A detailed method for performing embedding learning by using the prompt encoder 12 will be described in detail with reference to the drawings subsequent to FIG. 4.

When embedding learning is completed, the embedding system 10 may generate the embedding representation 14 for the data sample 13 by using the embedding model 11 and the learned prompt encoder 12. In addition, the embedding system 10 may directly perform a target task by using the embedding representation 14, or may provide the embedding representation 14 to a task execution device (not shown). Alternatively, the embedding system 10 may provide the embedding model 11 and the learned prompt encoder 12 to the task execution device (not shown).

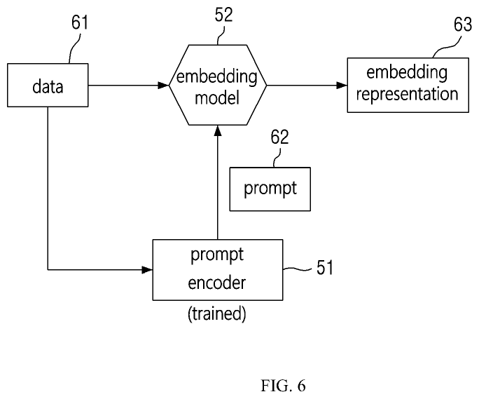

A detailed method for generating the embedding representation 14 by using the prompt encoder 12 learned in the inference step will be understood with reference to the description of FIG. 6.

The above-described embedding system 10 may be implemented as at least one computing device. For example, all functions of the embedding system 10 may be implemented by one computing device, a first function of the embedding system 10 may be implemented in a first computing device, and a second function of the embedding system 10 may be implemented in a second computing device. Alternatively, a particular function of the embedding system 10 may be implemented in a plurality of computing devices.

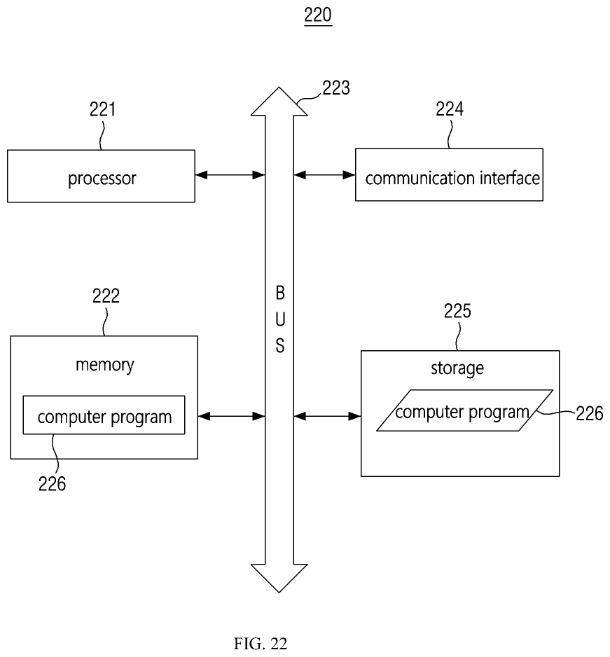

The computing device may include all of any devices having a computing function, and one example of the computing device will be understood with reference to FIG. 22. The computing device is an aggregate in which various components (e.g., a memory, a processor, etc.) interact with one another, and thus may be referred to as a ‘computing system’ in some cases. In addition, the computing system may mean an aggregate in which a plurality of computing devices interact with one another.

The embedding system 10 according to some embodiments of the present disclosure has been schematically described with reference to FIGS. 1 to 3. Hereinafter, various methods (i.e., detailed operations) that may be performed in the embedding system 10 will be described with reference to the drawings subsequent to FIG. 4.

Hereinafter, in order to provide convenience of understanding, it is assumed that all steps/operations of methods to be described later are performed in the above-described embedding system 10. Therefore, when a subject of a specific step/operation is omitted, it may be understood that the specific step/operation is performed in the embedding system 10. However, in an actual environment, some steps/operations of methods to be described later may be performed in another computing device.

Also, for clarity of the present disclosure, the description will be given while changing the reference numbers of the embedding model 11 and the prompt encoder 12 in accordance with the embodiment.

FIG. 4 is an exemplary flow chart illustrating a method for embedding data according to some embodiments of the present disclosure. However, this is only an example embodiment for achieving the object of the present disclosure, and some steps may be added or deleted as necessary.

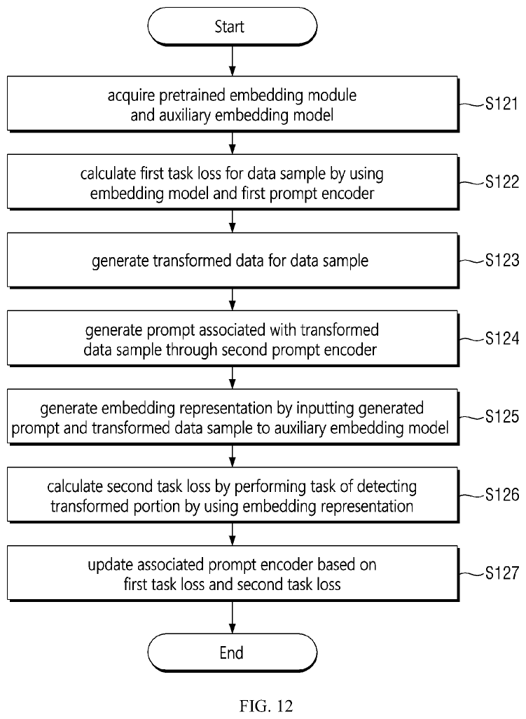

As shown in FIG. 4, the present embodiment relates to a method for performing embedding learning based on a single task. A method of performing embedding learning based on a plurality of related tasks will be described later with reference to the drawings subsequent to FIG. 12.

First, the present embodiment may start in step S41 of acquiring a pretrained embedding model. For example, when the type/format of the data sample is a text, the embedding system 10 may acquire a pretrained text embedding model (e.g., attention/transformer-based neural network model) such as BERT, RoBERTa, etc. The method of acquiring the embedding model is performed in any manner, and the pretraining may be also performed in any manner.

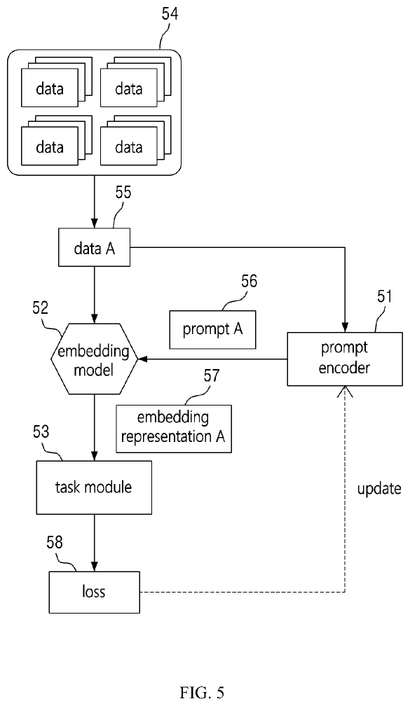

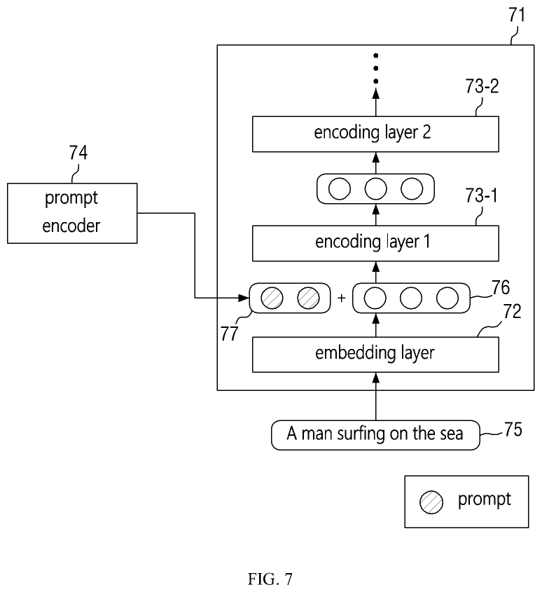

In step S42, a prompt associated with the data sample may be generated through the prompt encoder. For example, as shown in FIG. 5, the embedding system 10 may input a data sample 55 of the training set 54 to the prompt encoder 51 to generate a prompt 56 associated with the data sample 55. In this case, since the prompt 56 should be reflected in a neural network computation of an embedding model 52, the prompt 56 may have a type of a vector (or matrix) composed of continuous values (e.g., real number of float type). The data sample 55 may be digitized (or vectorized) and input to the prompt encoder 51, and this will be understood with reference to the description of FIG. 7.

As described above, the prompt encoder may mean a model (that is, a model with fewer learnable parameters than the embedding model) lighter than the embedding model. For example, the prompt encoder may be implemented as a neural network.

In step S43, the generated prompt and the data sample may be input to the embedding model, so that an embedding representation of the corresponding data sample may be generated. For example, as shown in FIG. 5, the embedding system 10 may generate an embedding representation 57 of the data sample 55 by inputting the data sample 55 and the prompt 56 associated with the data sample 55 to the embedding model 52.

Meanwhile, in this step S43, a method of providing (injecting) the prompt (e.g., the number of prompts, the manner in which the prompt is input to the embedding model, etc.) may vary depending on the embodiments.

In some embodiments, the prompt may be provided to a particular layer of the embedding model. This will be described later with reference to FIG. 7.

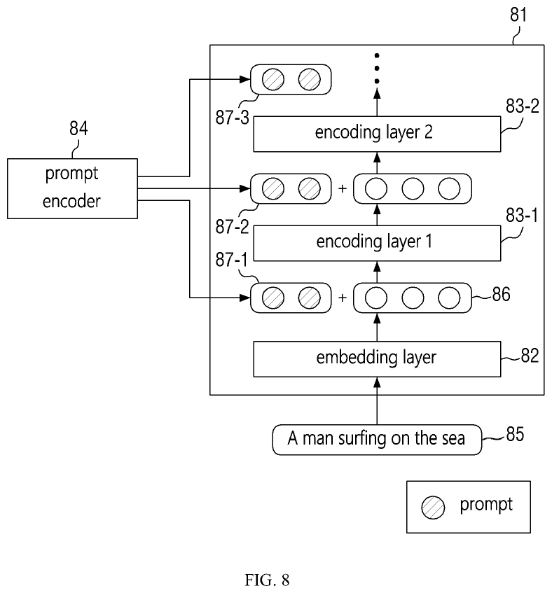

In some other embodiments, different prompts may be respectively provided to a plurality of layers constituting the embedding model. In this case, the effect of the prompts on the embedding model is enhanced, and the embedding model results in receiving more hints, and thus embedding performance may be improved. The present embodiment will be described later with reference to FIG. 8.

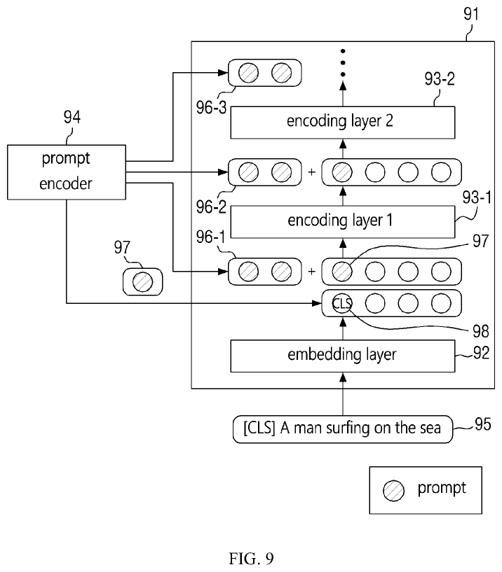

In some other embodiments, the embedding model may be a text embedding model (e.g., BERT) to which a special token is further input. In this case, the prompt may be reflected in the internal embedding representation associated with the special token, which will be described later with reference to FIG. 9.

In some other embodiments, the prompt may be generated based on various combinations of the above-described embodiments, and the generated prompt may be provided to the embedding model.

In step S44, a predefined task may be performed using the generated embedding representation, so that task loss may be calculated. For example, as shown in FIG. 5, the embedding system 10 may input the embedding representation 57 to a task module 53 and calculate a task loss 58 by using an output value (or prediction value) of the task module 53. The task loss 58 may be calculated in various ways depending on the type of the task, and the task module 53 may be implemented in various forms depending on the type of the task.

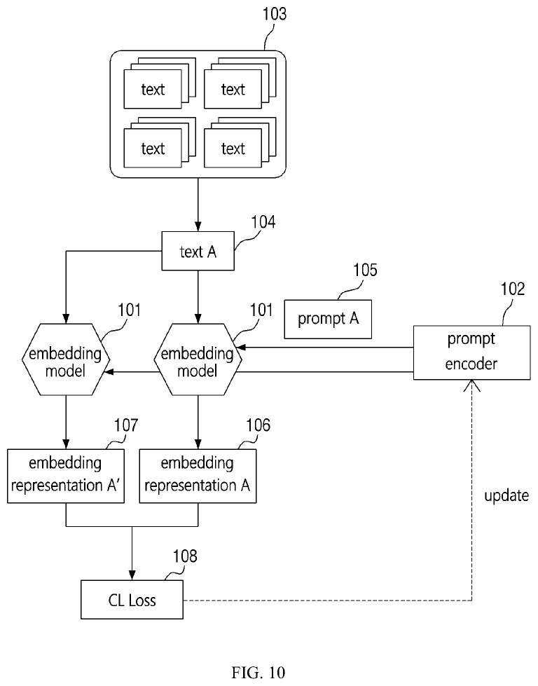

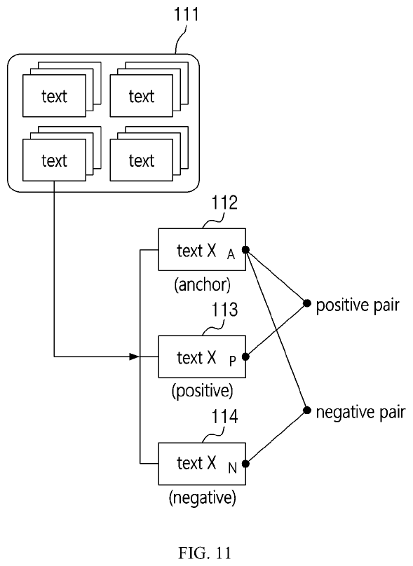

For example, when a target task is a task for classifying a data sample (e.g., type classification of text sentence (e.g., interrogative sentence, declarative sentence, etc.), emotion classification, class classification of an image, etc.), the task module 53 may be implemented as a neural network (e.g., MLP, etc.) outputting a prediction value for the class. As another example, when a target task is a task for predicting a mask token included in a text sample, the task module 53 may be implemented as a neural network (e.g., MLP, etc.) outputting a prediction value of a token unit. As still another example, when the target task is a contrastive learning task, the task module 53 may be implemented as a module for calculating similarity (e.g., cosine similarity) between two embedding representations. A process in which the contrastive learning task is performed will be described with reference to the description of FIGS. 10 and 11. The task module 53 may be omitted in some cases.

In step S45, the prompt encoder may be updated based on the task loss. For example, as shown in FIG. 5, the embedding system 10 may update the weight parameters of the prompt encoder 51 based on the task loss 58. By doing so, the prompt encoder 51 may be learned to generate a prompt (i.e., a prompt suitable for data sample 55) that is further helpful in the embedding model 52, and accuracy of the embedding representation 57 generated by the embedding model 52 may be also improved. However, a detailed update method may be partially changed depending on the embodiments.

In some embodiments, only the prompt encoder (e.g., 51) may be updated in a state that the embedding model (e.g., 52) is freezing. In this case, the cost required for embedding learning may be significantly reduced. That is, instead of a large-scale embedding model, only a lightweight prompt encoder may be learned, so that computing cost and time cost required for embedding learning may be significantly reduced.

In some embodiments, the prompt encoder (e.g., 51) and the task module (e.g., 53) may be learned in a state that the embedding model (e.g., 52) is freezing (however, when the task module is a learnable module). In this case, the overall learning cost may be greatly reduced. In addition, performance for that task may be also improved (i.e., the prompt encoder is learned to generate a prompt more suitable for the corresponding task, and as a result, the embedding model also generates an embedding representation that is more suitable for the corresponding task).

In some other embodiments, some updates (e.g., fine-tuning) may be performed even for the embedding model. In this case, the embedding performance may be more advanced. For example, the embedding system 10 may perform additional learning even for the embedding model after sufficiently learning the prompt encoder.

Meanwhile, in some embodiments, multiple tasks may be performed in conjunction with one embedding model. For example, the embedding system 10 may perform a first task by inputting an embedding representation (e.g., 57) generated by an embedding model (e.g., 52) to a first task module, and may perform a second task by inputting the same to a second task module. The embedding system 10 may update the prompt encoder (e.g., 51 of FIG. 5) or the like based on loss of the first task and loss of the second task. In this case, the prompt encoder may be updated through various tasks and thus learned to generate a prompt, which is generally useful in performing various tasks.

The above-described steps S42 to S45 may be repeatedly performed for a plurality of data samples (i.e., training sets) until a learning end condition is satisfied. By doing so, the prompt encoder may be learned to generate a prompt suitable for given data samples, and the embedding model may generate a more accurate embedding representation by using the prompt. The learning end condition may be defined in various forms based on the number of learning times (number of epochs), task loss, learning time, and the like, but the scope of the present disclosure is not limited thereto. The learning end condition may be defined in any form.

When embedding learning ends, the embedding system 10 may generate an embedding representation for an input data sample by using the embedding model and the learned prompt encoder. For example, it is assumed that the prompt encoder 51 has been learned as illustrated in FIG. 5. In this case, as shown in FIG. 6, the embedding system 10 may generate a prompt 62 associated with the data sample 61 through the learned prompt encoder 51, and may generate an embedding representation 63 of the data sample 61 by inputting the generated prompt 62 and the data sample 61 to the embedding model 52. In some cases, the embedding system 10 may further perform the target task by using the embedding representation 63.

The method for embedding data according to some embodiments of the present disclosure has been generally described with reference to FIGS. 4 to 6. Hereinafter, various embodiments related to a method for providing a prompt will be described with reference to FIGS. 7 to 9.

FIGS. 7 to 9 illustrate a case that an embedding model (e.g., 71) is a text embedding model composed of a plurality of layers, and it is assumed that the embedding model (e.g., 71) is designed to have a structure similar to that of a bidirectional encoder representations from transformers (BERT). The structure and operation principle of the BERT are already familiar with a person skilled in the art, and thus their description will be omitted.

FIG. 7 is an exemplary view illustrating a method for providing a prompt according to some embodiments of the present disclosure.

As shown in FIG. 7, in this embodiment, a prompt encoder 74 may provide a prompt 77 to a particular layer of the embedding model 71. Although FIG. 7 illustrates a case that the prompt 77 is composed of two vectors (i.e., prompt vectors), the number of vectors constituting the prompt 77, the number of dimensions of the vector (i.e., the number of continuous values constituting one vector) may vary.

In detail, it is assumed that the embedding model 71 is composed of one or more embedding layers 72 and a plurality of encoding layers (e.g., 73-1 and 73-2). At this time, the embedding layer 72 may be a layer for receiving a token sequence (e.g., a sequence of one-hot token vector) for the text sample 75 and performing an internal embedding representation 76, and the encoding layers (e.g., 73-1 and 73-2) may be layers for performing an encoding computation. The embedding layer 72 is implemented with a neural network such as multi-layer perceptron (MLP), and the encoding layer (e.g., 73-1) may be implemented with a self-attention-based neural network. However, the scope of the present disclosure is not limited thereto. In some cases, the embedding layer 72 may be regarded as a neural network layer positioned outside the embedding model 71.

In the above case, the prompt encoder 74 may generate a prompt 77 associated with the text sample 75. For example, the prompt encoder 74 may generate the prompt 77 associated with the text sample 75 by receiving a vector representation (e.g., 76) of the text sample 75 and performing an appropriate neural network computation (i.e., encoding computation) for the vector representation (e.g., 76).

Next, the prompt encoder 74 may provide (inject) the generated prompt 77 to a particular layer (e.g., 73-1) of the embedding model 71. For example, as shown, the prompt 77 may be provided to the first encoding layer 73 and reflected in an input value 76 (e.g., an internal embedding representation) of the first encoding layer 73, but the scope of the present disclosure is not limited thereto. However, when the prompt 77 is input to a relatively front encoding layer (e.g., 73-1), an influence of the prompt 77 on the embedding model 71 may be further enhanced.

The manner of reflecting the prompt 77 may be, for example, concatenation, addition, multiplication, element-wise product, replacement, etc., but the scope of the present disclosure is not limited thereto. In some cases, the prompt 77 and an internal value (e.g., 76) of the embedding model may be aggregated through a separate neural network layer (or encoding layer).

Hereinafter, a method for providing a prompt according to some other embodiments of the present disclosure will be described with reference to FIG. 8. However, for clarity of the present disclosure, descriptions of the same contents as those of the previous embodiments will be omitted.

As shown in FIG. 8, in the present embodiment, a prompt encoder 84 may provide a plurality of prompts (e.g., 87-1 to 87-3) to different layers (e.g., 83-1 and 83-2) of an embedding model 81.

In detail, it is assumed that the embedding model 81 is composed of one or more embedding layers 82 and a plurality of encoding layers (e.g., 83-1 and 83-2), similarly to FIG. 7. In this case, the prompt encoder 84 may generate a number of prompts (e.g., 87-1 to 87-3) associated with the text sample 85 and provide the generated prompts (e.g., 87-1 to 87-3) to different layers (e.g., 83-1 and 83-2) of the embedding model 81. For example, the prompt encoder 84 may provide a first prompt 87-1 to a first encoding layer 83-1 and provide a second prompt 87-2 to a second encoding layer 83-2. By doing so, the respective prompts (e.g., 87-1 to 87-3) may be reflected in computation of the respective encoding layers (e.g., 81-2 and 81-2), and the influence of the prompts (e.g., 87-1 to 87-3) on the embedding model 81 may be further enhanced. Therefore, the effect of prompt-based embedding learning may be further improved.

Hereinafter, a method for providing a prompt according to some other embodiments of the present disclosure will be described with reference to FIG. 9.

As shown in FIG. 9, in the present embodiment, a prompt encoder 94 may generate and provide a prompt 97 (hereinafter, referred to as ‘special prompt’) associated with a special token. FIG. 9 illustrates a case that a special prompt 97 is further provided in comparison with FIG. 8, and illustrates a case that a special token is a ‘CLS token (classification token)’.

In detail, it is assumed that the embedding model 91 is composed of one or more embedding layers 92 and a plurality of encoding layers (e.g., 93-1 and 93-2), similarly to FIG. 8. In this case, the prompt encoder 94 may generate one or more prompts (e.g., 96-1 to 96-3) associated with a text sample 95. In addition, the prompt encoder 94 may further generate the special prompt 97. When the prompt encoder 94 is composed of a plurality of neural network layers, the special prompt 97 may be generated via a layer different from the general prompt (e.g., 96-1), but the scope of the present disclosure is not limited thereto.

Next, the prompt encoder 94 may provide (inject) the generated prompts (e.g., 96-1 to 96-3 and 97) to the embedding model 91. For example, the prompt encoder 94 may reflect the special prompt 97 to an internal embedding representation 98 associated with the special token (e.g., CLS token). By doing so, the influence of the prompt (e.g., 97) on the embedding model 91 may be further enhanced.

The manner of reflecting the special prompt 97 may be, for example, replacement, concatenation, addition, multiplication, element-wise product, etc., but the scope of the present disclosure is not limited thereto. In some cases, the prompt 97 and an internal value (e.g., an internal embedding representation of the text sample 95) of the embedding model may be aggregated through a separate neural network layer (or encoding layer). However, according to experimental results of the inventors of the present disclosure, it has been confirmed that embedding performance is most improved when the internal embedding representation 98 associated with the special token (e.g., CLS token) is replaced with the special prompt 97.

The reason why embedding performance is improved due to the special prompt 97 may be understood as follows, for example. In the embedding vector associated with the CLS token, information of the input text sample 95 is most aggregated, and the corresponding embedding vector may be regarded as a vector in which the effort (i.e., processing) of the embedding model 91 is concentrated. Therefore, when the special prompt 97 is reflected (e.g., replaced) in an internal embedding vector associated with the CLS token, influence of the prompt encoder 94 on the embedding model 91 may be greatly increased, and performance of the embedding model 91 is greatly improved as the prompt is advanced (i.e., the prompt encoder is learned).

The method for providing a prompt according to various embodiments of the present disclosure has been described above with reference to FIGS. 7 to 9. Hereinafter, various embodiments related to a contrastive learning task will be described with reference to FIGS. 10 and 11. Hereinafter, for convenience of understanding, it is assumed that the type/format of the data sample is a text, but the scope of the present disclosure is not limited thereto.

FIG. 10 is an example view illustrating a process of performing a contrastive learning task according to some embodiments of the present disclosure.

As shown in FIG. 10, it is assumed that a contrastive learning task is performed for a specific text sample 104 included in a training set 103. In this case, the embedding system 10 may generate a prompt 105 associated with the text sample 104 via the prompt encoder 102 and generate multiple embedding representations 106 and 107 for the text sample 104 by inputting the generated prompt 105 to the embedding model 101.

For example, the embedding system 10 may generate a first embedding representation 106 by inputting the text sample 104 and the prompt 105 to the embedding model 101 in which drop-out is set, and may generate a second embedding representation 107 similar to a first embedding representation 106 by re-inputting the text sample 104 and the prompt 105 to the embedding model 101.

Alternatively, unlike the example shown in FIG. 10, the embedding system may generate the second embedding representation (e.g., 107) by inputting a positive sample (not shown) for the text sample 104 to the embedding model 102. For example, the embedding system 10 may generate a positive sample (not shown) for the text sample 104 via a data augmentation technique, and may generate the second embedding representation (e.g., 107) by inputting a prompt (not shown) associated with the positive sample to the embedding model 101.

Next, the embedding system 10 may calculate a loss 108 regarding the contrastive learning task based on a similarity (e.g., cosine similarity) between the first embedding representation 106 and the second embedding representation 107, and may update the prompt encoder 102 based on the calculated loss 108.

Meanwhile, in some other embodiments, as shown in FIG. 11, a training set 111 may be composed of a pair (triple) of an anchor sample 112, a positive sample 113, and a negative sample 114 (i.e., the case that the training set 111 is a label data set that includes a positive pair and a negative pair). In this case, the embedding system 10 may perform a contrastive learning task in a direction in which similarity of the positive pair 112 and 113 is increased, and may perform the contrastive learning task in a direction in which similarity of the negative pair 112 and 114 is reduced.

The method for embedding data according to some embodiments of the present disclosure has been described with reference to FIGS. 4 to 11. According to the above description, the prompt encoder, which is lighter than a pretrained embedding model, is introduced, and the prompt encoder is learned instead of the embedding model, whereby costs required for embedding learning may be significantly reduced. In addition, in case of the text embedding model that further receives a special token, such as BERT, the special prompt may be reflected in the internal embedding representation associated with the special token. In this case, learning costs may be reduced and embedding performance may be improved.

Hereinafter, a method for embedding data according to some other embodiments of the present disclosure will be described with reference to the drawings subsequent to FIG. 12. However, for clarity of the present disclosure, descriptions of the same contents as those of the previous embodiment will be omitted.

FIG. 12 is an exemplary flow chart illustrating a method for embedding data according to some other embodiments of the present disclosure.

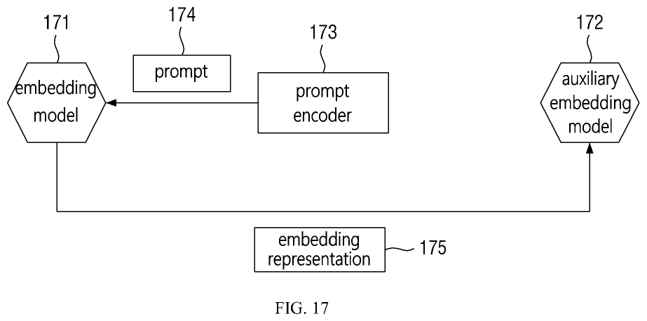

As shown in FIG. 12, the present embodiment relates to a method for performing embedding learning based on a plurality of tasks. In FIG. 12, it is assumed that the number of target tasks is two and the number of prompt encoders is one, but the scope of the present disclosure is not limited thereto. For example, the number of target tasks may be three or more, and the number of prompt encoders may be two or more. The case that two prompt encoders are used will be described with reference to the description of FIGS. 17 to 19. Hereinafter, for clarity of description, two target tasks are referred to as a ‘first task’ and a ‘second task’, and an expression of ‘first’ or ‘second’ is attached to module/data associated with each task as necessary.

First, the present embodiment may start in step S121 of acquiring a pretrained embedding model and a pretrained auxiliary embedding model. In this case, the auxiliary embedding model is a model used to assist embedding learning (e.g., learning of the prompt encoder), may be the same model as the embedding model, or may be another model. The auxiliary embedding model may be used only in the learning step and discarded in the inference step, but the scope of the present disclosure is not limited thereto.

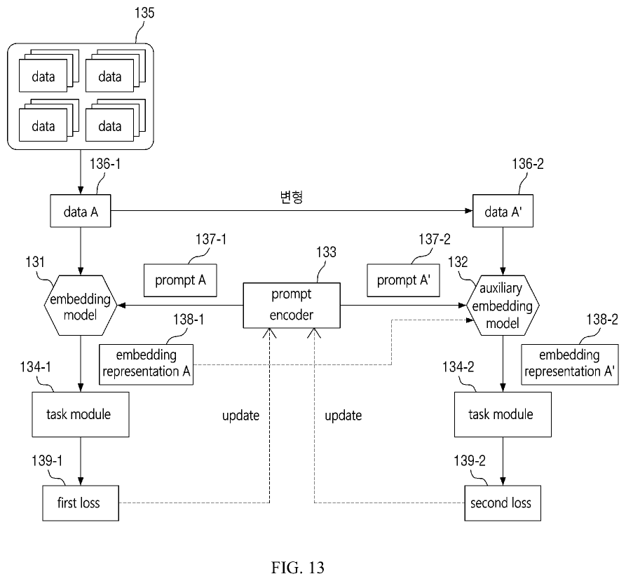

In step S123, a first task loss for a data sample may be calculated using the embedding model and the prompt encoder. For example, as shown in FIG. 13, the embedding system 10 may generate a first prompt 137-1 associated with a data sample 136-1 of a training set 135 through a prompt encoder 133 and generate an embedding representation 138-1 (i.e., a first embedding representation) of the data sample 136-1 by inputting the data sample 136-1 and the first prompt 137-1 to the embedding model 131. In addition, the embedding system 10 may calculate a first task loss 139-1 by performing a first task through a first task module 134-1. This step will be further understood with reference to the description of FIG. 4.

In step S123, a transformation data sample for the data sample may be generated. For example, the embedding system 10 may generate the transformation data sample by transforming at least a portion of the data sample through a transformation module. At this time, the transformation module may be a module (e.g., a generator implemented with a neural network) learned to transform an input data sample, or may be a module implemented to transform the input data sample in accordance with a predefined algorithm.

In this step S123, a method of transforming a data sample may be any method. For example, when the data sample is a text sample, the embedding system 10 may transform a given text sample in a manner such as token deletion (e.g., masking), token addition, token replacement, token modification, and the like. As another example, when the data sample is an image sample, the embedding system 10 may transform a given image sample in a manner such as transformation (e.g., noise addition, color change, removal, etc.) of a portion (e.g., patch) of the image, patch addition, patch replacement, etc., but the scope of the present disclosure is not limited thereto.

In step S124, a prompt (i.e., a second prompt) associated with the transformation data sample may be generated via a prompt encoder. For example, as shown in FIG. 13, the embedding system 10 may generate a second prompt 137-2 associated with a transformation data sample 136-2 by inputting the transformation data sample 136-2 to the prompt encoder 133.

In step S125, an embedding representation (i.e., a second embedding representation) of the transformation data sample may be generated by inputting the second prompt and the transformation data sample to the auxiliary embedding model. For example, as shown in FIG. 13, the embedding system 10 may generate a second embedding representation 138-2 by inputting the transformation data sample 136-2 and the second prompt 137-2 to an auxiliary embedding model 132.

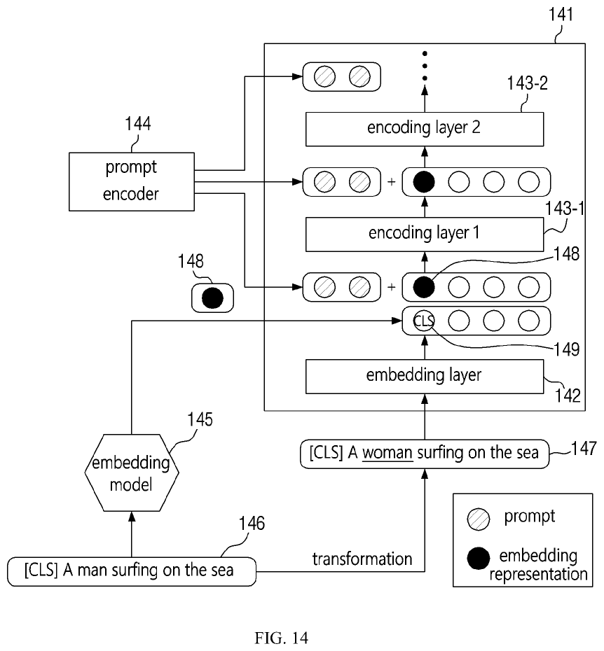

In some embodiments, as shown in FIG. 13, the first embedding representation 138-1 may be further input to the auxiliary embedding model 132 to generate the second embedding representation 138-2. In this case, as the first embedding representation 138-1 acts as a kind of hint, the second embedding representation 138-2 may be generated in a form that is more suitable for a second task of determining whether there is transformation or detecting a transformed portion (e.g., a difference between two data samples 136-1 and 136-2 may be well reflected in the second embedding representation 138-2), and in this regard, a further description will be made with reference to FIG. 14.

In some embodiments, the first embedding representation (e.g., 138-1) may not be provided to the auxiliary embedding model (e.g., 132) or the provision of the first embedding representation may be suspended (stopped) to increase the difficulty of the second task. For example, the embedding system 10 may perform embedding learning (e.g., prompt encoder learning) while providing a first embedding representation to the auxiliary embedding model until a predetermined time point, and may perform embedding learning in a state that the provision of the first embedding representation is suspended after a certain time period has elapsed.

In step S126, the second task may be performed, whereby second task loss may be calculated. For example, as shown in FIG. 13, the embedding system 10 may input the second embedding representation 138-2 to a second task module 134-2 and perform the second task through the second task module 134-2. A second task loss 139-2 may be calculated based on the result of execution of the second task.

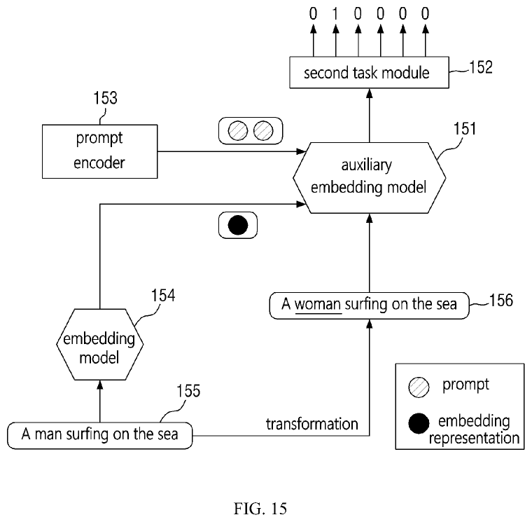

Meanwhile, the second task may have various detailed types. For example, when a transformation data sample (e.g., 136-2) is generated through class transformation (e.g., transforming the type of sentence from declarative sentence to interrogative sentence, etc.), a task for predicting the transformed class may be used as the second task. As another example, when the transformation data sample is generated by transforming a portion of the data sample, a task for determining (predicting) whether there is transformation of a specific data sample or detecting a transformed portion may be used as the second task. At this time, the task for detecting the transformed portion may be understood to encompass a task (e.g., mask token prediction) that predicts an original value of the transformed portion (e.g., mask token, deleted token, added token, etc. in case of a text sample). An example of the second task will be described later with reference to FIG. 15.

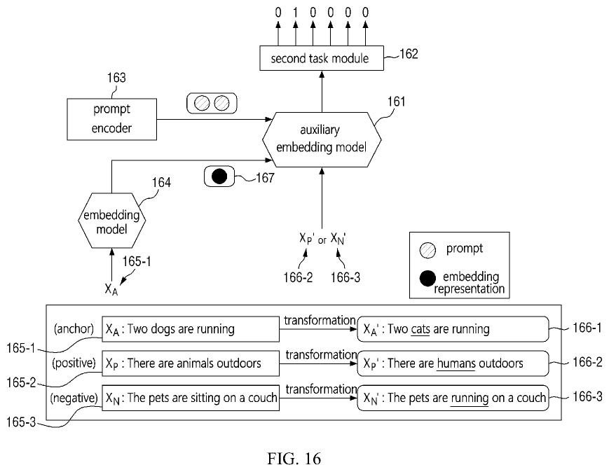

Meanwhile, in some embodiments, the training set may be composed of a pair (triple) of an anchor sample, a positive sample, and a negative sample, as illustrated in FIG. 10. In this case, a method of performing the second task may be partially changed in order to increase the difficulty of the second task, which will be described later with reference to FIG. 16.

In step S127, the associated prompt encoder may be updated based on the first task loss and the second task loss. For example, as shown in FIG. 13, the embedding system 10 may sum (e.g., weighted sum) the first task loss 139-1 and the second task loss 139-2 to calculate total loss and update the prompt encoder 133 based on the calculated total loss. In this case, since the prompt encoder 133 may be learned to generate a sophisticated prompt by capturing even a fine transformed portion of the data sample, embedding performance may be further improved. The prompt encoder 133 may be updated in a state that the embedding model 131 and the auxiliary embedding model 132 are freezing, but the scope of the present disclosure is not limited thereto. As described above, in some cases, the embedding model 131 and the auxiliary embedding model 132 may be updated together, and the task modules 134-1 and 134-2 may be also updated together.

Hereinafter, an embodiment in which the first embedding representation is further provided to the auxiliary embedding model will be described with reference to FIG. 14.

FIG. 14 illustrates a case that a type/format of a data sample is a text, and an auxiliary embedding model 141 is composed of one or more embedding layers 142 and a plurality of encoding layers (e.g., 143-1 and 143-2). This will be understood with reference to the description of FIG. 7.

As shown in FIG. 14, it is assumed that a first embedding representation 148 for a text sample 146 has been generated through an embedding model 145, some tokens of the text sample 146 have been transformed to generate a transformation text sample 147, and a second prompt encoder 144 provides (injects) multiple prompts to the auxiliary embedding model 141.

In the above case, the embedding system 10 may further provide the first embedding representation 148 to the auxiliary embedding model 141. In this case, since the auxiliary embedding model 141 may generate an embedding representation (i.e., the second embedding representation) of the transformed text sample 147 with reference to the first embedding representation 148, the second embedding representation may be generated in a form suitable for the second task. For example, a difference (i.e., transformed portion) between the two text samples 146 and 147 may be well reflected in the generated second embedding representation.

Meanwhile, FIG. 14 illustrates an example in which the first embedding representation 148 is reflected (e.g., replaced) in an internal embedding representation 149 associated with a special token (e.g., CLS token), but the scope of the present disclosure is not limited thereto, and the first embedding representation 148 may be reflected in another internal embedding representation and input to another layer of the auxiliary embedding model.

Hereinafter, embodiments related to a process of performing a transformed token detection task will be described with reference to FIGS. 15 and 16.

FIG. 15 is an exemplary view illustrating a process of performing a transformed token detection task according to some embodiments of the present disclosure.

As shown in FIG. 15, when the data sample is a text sample (see 155), a task for detecting the transformed token may be used as the second task. In addition, a second task module 152 for performing the corresponding task may be implemented as a neural network for outputting a prediction value related to whether each token is transformed.

In detail, the second task module 152 may predict whether each token is transformed, based on an embedding representation of the transformed text sample 156 generated by the auxiliary embedding model 151. In addition, a second task loss may be calculated based on a difference between the prediction result and a correct answer (see 156).

The description of the prompt encoder 153 and the embedding model 154 will be omitted in order to exclude the redundant description.

Hereinafter, embodiments related to a method in which a second task is performed when a training set is composed of a pair (triple) of an anchor sample, a positive sample and a negative sample will be described with reference to FIG. 16.

FIG. 16 illustrates a case that a type/format of a data sample is text and a second task is a transformed token detection task.

As shown in FIG. 16, it is assumed that an anchor sample 165-1, a positive sample 165-2 and a negative sample 165-3 are composed of one pair (triple), and transformed samples 166-1 to 166-3 are generated from the pair (triple). It is also assumed that a transformed token detection task is performed for the transformed positive sample 166-2 or the transformed negative sample 166-3.

In the above case, the embedding system 10 may generate an embedding representation 167 (i.e., the first embedding representation) for the anchor sample 165-1 or the transformed anchor sample 166-1 through the embedding model 164. In addition, the embedding system 10 may provide the first embedding representation 167 to the auxiliary embedding model 161 to generate a second embedding representation (not shown) for the transformed positive sample 166-2 or the transformed negative sample 166-3. In this case, since the auxiliary embedding model 161 generates the second embedding representation with reference to the first embedding representation 167 with attenuated hint, the difficulty of the transformed token detection task is increased, and as a result, performance of the prompt encoder 163 may be improved.

The description of the second task module 162 will be made with reference to the description content of FIG. 15.

Meanwhile, there has been a description assuming a model architecture in which only one prompt encoder is present, but various model architectures for embedding learning may be designed. Hereinafter, various types of model architectures will be described with reference to FIGS. 17 to 19.

FIG. 17 is an exemplary view illustrating a model architecture according to some embodiments of the present disclosure.

As shown in FIG. 17, in this embodiment, a model architecture may be configured such that one prompt encoder 173 provides a prompt 174 to only an embedding model 171. In this case, the auxiliary embedding model 172 may operate to receive an embedding representation 175 (i.e., the first embedding representation) from the embedding model 171 and generate a second embedding representation (not shown) based on the first embedding representation 175.

In the present embodiment, the prompt encoder 173 may be updated or not based on the second task loss.

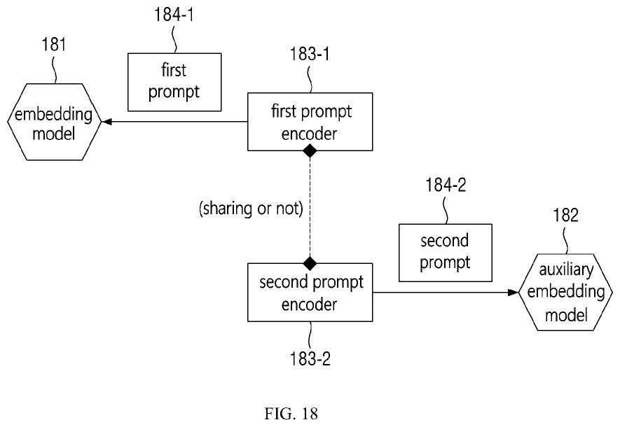

Hereinafter, a model architecture according to some other embodiments of the present disclosure will be described with reference to FIG. 18.

As shown in FIG. 18, in the present embodiment, a model architecture may be configured such that a first prompt encoder 183-1 provides a first prompt 184-1 to an embedding model 181 and a second prompt encoder 183-2 provides a second prompt 184-2 to an auxiliary embedding model 182.

At this time, the first prompt encoder 183-1 and the second prompt encoder 183-2 may be configured to share at least some weight parameters or not.

For reference, it may be understood that the fact that the first prompt encoder 183-1 and the second prompt encoder 183-2 share all weight parameters means that the first prompt encoder 183-1 and the second prompt encoder 183-2 are the same prompt encoders.

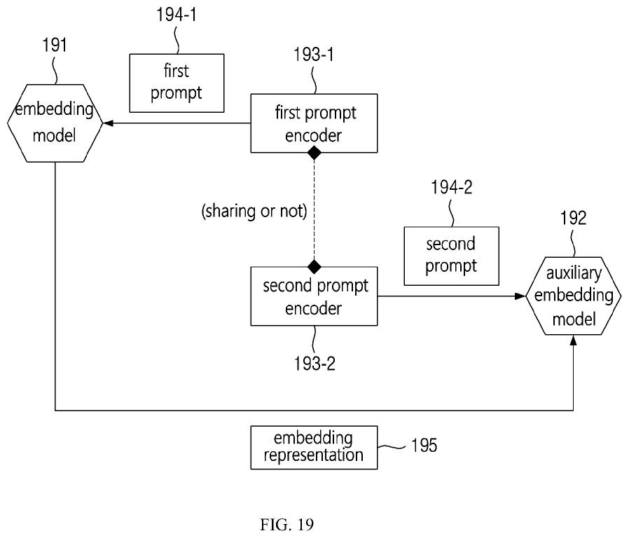

Hereinafter, a model architecture according to some other embodiments of the present disclosure will be described with reference to FIG. 19.

As shown in FIG. 19, in the present embodiment, a model architecture may be configured such that a first prompt encoder 193-1 provides a first prompt 194-1 to an embedding model 191, a second prompt encoder 193-2 provides a second prompt 194-2 to an auxiliary embedding model 192, and the embedding model 191 provides an embedding representation 195 (i.e., the first embedding representation) to the auxiliary embedding model 192.

Similarly to the previous embodiment, the first prompt encoder 193-1 and the second prompt encoder 193-2 may be configured to share at least some weight parameters or not.

The method for embedding data according to some other embodiments of the present disclosure has been described with reference to FIGS. 12 to 19. As described above, associated prompt encoders may be learned based on a plurality of task losses calculated as a plurality of associated tasks are performed. Therefore, performance of the prompt encoder may be further improved, and as a result, embedding performance may be further improved.

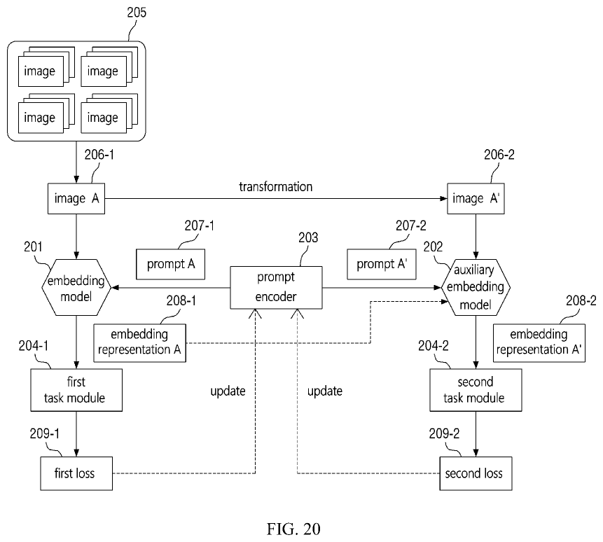

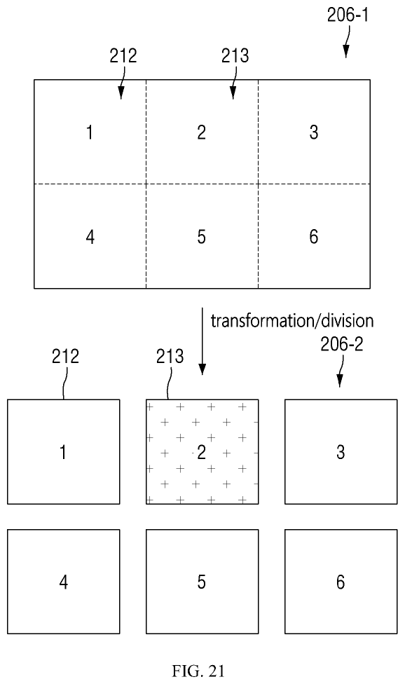

Hereinafter, in order to provide better understanding, a process in which embedding learning is performed when a type/format of a data sample is an image will be described with reference to FIGS. 20 and 21.

FIG. 20 is an exemplary view illustrating an embedding learning process for an image sample according to some embodiments of the present disclosure.

As shown in FIG. 20, the embedding system 10 may perform a first task for an image sample 206-1 of a training set 205 to calculate a first task loss 209-1. The first task may be various types of tasks such as a contrastive learning task, an image classification task, etc. As described above, a first task module 204-1 may perform a first task based on a first embedding representation 208-1, and the first embedding representation 208-1 may be generated by an embedding model 201 that has received a first prompt 207-1.

Next, the embedding system 10 may generate a transformed image sample 206-2 for the image sample 206-1. For example, the embedding system 10 may generate the transformed image sample 206-2 by dividing the image sample 206-1 into a plurality of patches (e.g., 212 and 213) and transforming (e.g., noise addition, pixel value change, etc.) at least some of the patches 213 as shown in FIG. 21, but the scope of the present disclosure is not limited thereto.

Next, the embedding system 10 may perform a second task (that is, a task for determining whether there is transformation or detecting a transformed portion) and calculate a second task loss 209-2 by using an auxiliary embedding model 202 and a second task module 204-2. Refer to the descriptions of the previous embodiments for the case that the auxiliary embedding model 202 receives the second prompt 207-2 and the transformed image sample 206-2 to generate the embedding representation (i.e., the second embedding representation) of the transformed image sample 206-2.

Next, the embedding system 10 may update the prompt encoder 203 based on the first task loss 209-1 and the second task loss 209-2.

The embedding learning process for the image sample has been described as above. Hereinafter, an experiment result for the above-described method for embedding data will be briefly described.

The inventors of the present disclosure performed embedding learning in accordance with the method (hereinafter, referred to as a ‘proposal method’) illustrated in FIG. 12 to prove the effect of the above-described method for embedding data. In this case, the same BERT model was used as the embedding model and the auxiliary embedding model, and the embedding learning was performed by updating only the prompt encoder by using a non-pair general text set (see ‘unsupervised learning’ in Table 1) and a pair text set (see ‘supervised learning’ in Table 1) as illustrated in FIG. 11. Also, a contrastive learning task and a transformed token detection task were used as the target tasks.

In addition, the inventors of the present disclosure evaluated performance of embedding according to the proposed method, and compared the evaluated performance with ‘SimCSE’. A Semantic Textual Similarity (STS), alignment, and uniformity were used as evaluation metrics.

For reference, SimCSE refers to a method for training a BERT model based on a contrastive learning task, and its detailed description will be understood with reference to the paper named ‘Simple Contrastive Learning of Sentence Embeddings’.

Also, STS refers to a value obtained by calculating the degree of correlation between embedding vector similarity and correct answer similarity (that is, a similarity value determined by a person) for a given sentence pair in accordance with a Spearman's rank correlation coefficient. In addition, alignment means a metric indicating how close positive pairs are to an embedding space, and may be calculated based on an average embedding distance for the positive pairs (e.g., it means that the smaller the value is, the higher embedding performance is). Finally, uniformity means a metric indicating how evenly the embedding vector of the text samples is distributed in the embedding space, and may be calculated based on the distance of the text samples (e.g., it means that the smaller value is, the higher embedding performance is). Additional descriptions and equations for STS, alignment, and uniformity are made with reference to the paper named ‘Simple Contrastive Learning of Sentence Embeddings’.

The experimental results are listed in Table 1 below. In Table 1, the ‘proposal method+CLS’ means a case that a special prompt is further provided (see FIG. 9), and the number of parameters related to the proposal method means the number of weight parameters of the prompt encoder.

TABLE 1

| | | The number of | | | |
|---|---|---|---|---|---|
| Division | | parameters | Alignment | Uniformity | STS |
| | SimCSE | 110M | 0.177 | −2.313 | 76.16 |
| Unsupervised | Proposal | 2.6M | 0.062 | −1.2627 | 79.02 |
| learning | method | | | | |
| Supervised | SimCSE | 110M | 0.0898 | −1.7635 | 81.37 |
| learning | Proposal | 2.6M | 0.0862 | −2.1093 | 81.52 |
| | method + CLS | | | | |

Referring to Table 1, it may be confirmed that the number of parameters learned by the proposal method is merely about 2% of SimCSE (that is, a general BERT model). Therefore, it is noted that the cost required for embedding learning may be significantly reduced when the proposal method is applied.

Nevertheless, it is noted that embedding performance according to the proposal method is generally better than SimCSE. In detail, when embedding learning is performed using a general text set, it can be seen that STS score and alignment are greatly improved compared to SimCSE (see the aspect that STS score is higher and alignment value is smaller in ‘unsupervised learning’). When embedding learning is performed with a pair text set while providing more special prompts, it can be seen that performance is more improved in all respects than SimCSE (see the aspect that STS score is higher and alignment and uniformity values are smaller in ‘supervised learning’). Through this experiment result, it can be seen that the proposal method may improve embedding performance while reducing learning cost, and further, when a special prompt is further used, embedding performance may be further improved.

The performance experiment result for the above-described embedding method has been briefly described with reference to Table 1. Hereinafter, an exemplary computing device 220 capable of implementing an embedding system 10 according to some embodiments of the present disclosure will be described with reference to FIG. 22.

FIG. 22 is an exemplary hardware schematic view illustrating a computing device 220.

As shown in FIG. 22, the computing device 220 may include one or more processors 221, a bus 223, a communication interface 224, a memory 222 for loading a computer program 226 performed by the processor 221, and a storage 225 for storing the computer program 226. However, only components related to the embodiment of the present disclosure are shown in FIG. 22. Therefore, a person skilled in the art to which the present disclosure pertains may know that general-purpose components other than the components shown in FIG. 22 may be further included. That is, the computing device 220 may further include various components in addition to the components shown in FIG. 22. Also, in some cases, the computing device 220 may be configured in a form in which some of the components shown in FIG. 22 are omitted. Hereinafter, each component of the computing device 220 will be described.

The processor 221 may control the overall operation of each component of the computing device 220. The processor 221 may include at least one of a Central Processing Unit (CPU), a Micro Processor Unit (MPU), a Micro Controller Unit (MCU), a Graphic Processing Unit (GPU), or any type of processor well known in the technical field of the present disclosure. In addition, the processor 221 may perform computation for at least one application or program for executing an operation/method according to embodiments of the present disclosure. The computing device 220 may include one or more processors.

Next, the memory 222 may store various data, commands, and/or information. The memory 222 may load the computer program 226 from the storage 225 to execute the operation/method according to the embodiments of the present disclosure. The memory 222 may be implemented as a volatile memory such as a RAM, but the technical scope of the present disclosure is not limited thereto.

Next, the bus 223 may provide a communication function between components of the computing device 220. The bus 223 may be implemented as various types of buses such as an address bus, a data bus, and a control bus.

Next, the communication interface 224 may support wired/wireless Internet communication of the computing device 220. In addition, the communication interface 224 may support various communication methods other than internet communication. To this end, the communication interface 224 may include a communication module well known in the art of the present disclosure.

Next, the storage 225 may non-temporarily store one or more computer programs 226. The storage 225 may include a non-volatile memory such as a Read Only Memory (ROM), an Erasable Programmable ROM (EPROM), an Electrically Erasable Programmable ROM (EEPROM) and a flash memory, a hard disk, a detachable disk, or any form of a computer-readable recording medium well known in the art to which the present disclosure pertains.

Next, the computer program 226 may include one or more instructions to allow the processor 221 to perform the operation/method according to various embodiments of the present disclosure when loaded into the memory 222. That is, the processor 221 may perform operations/methods according to various embodiments of the present disclosure by executing the one or more instructions.

For example, the computer program 226 may include instructions to perform an operation of acquiring a pretrained embedding model, an operation of generating a prompt associated with a data sample through a prompt encoder, an operation of generating an embedding representation of the data sample by inputting the prompt and the data sample to an embedding model, an operation of calculating a task loss by performing a predefined task by using the embedding representation, and an operation of updating the prompt encoder based on the task loss. In this case, the embedding system 10 according to some embodiments of the present disclosure may be implemented through the computing device 220.

Meanwhile, in some embodiments, the computing device 220 shown in FIG. 22 may mean a virtual machine implemented based on a cloud technology. For example, the computing device 220 may be a virtual machine operating in one or more physical servers included in a server farm. In this case, at least some of the processor 221, the memory 222, and the storage 225, which are shown in FIG. 22, may be virtual hardware, and the communication interface 224 may be also implemented as a virtualized networking element such as a virtual switch.

The exemplary computing device 220 capable of implementing the embedding system 10 according to some embodiments of the present disclosure has been described with reference to FIG. 22.

So far, a variety of embodiments of the present disclosure and the effects according to embodiments thereof have been mentioned with reference to FIGS. 1 to 22. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the example embodiments without substantially departing from the principles of the present disclosure. Therefore, the disclosed example embodiments of the disclosure are used in a generic and descriptive sense only and not for purposes of limitation.

What is claimed is:

1. A method for embedding data, the method being performed by at least one computing device and comprising:
acquiring a pretrained embedding model;
generating a prompt associated with a data sample through a prompt encoder, the prompt encoder being lighter than the embedding model;
generating an embedding representation of the data sample by inputting the prompt and the data sample to the embedding model;
calculating a task loss by performing a predefined task by using the embedding representation; and
updating the prompt encoder based on the task loss.

2. The method of claim 1, wherein the updating the prompt encoder includes updating the prompt encoder in a state of freezing the embedding model.

3. The method of claim 1, wherein the generated prompt includes a first prompt and a second prompt, and
the first prompt and the second prompt are input to different layers of the embedding model.

4. The method of claim 1, wherein the data sample is a text sample,
the embedding model is a model for further receiving a special token in addition to tokens included in the text sample, and
the generated prompt is reflected in an internal embedding representation of the embedding model associated with the special token.

5. The method of claim 4, wherein the generating the embedding representation includes replacing the internal embedding representation associated with the special token with the generated prompt to generate the embedding representation.

6. The method of claim 1, wherein the task loss and the embedding representation are a first task loss and a first embedding representation, respectively,
the method further comprising:
generating a transformed data sample for the data sample;
generating a second embedding representation by inputting the transformed data sample to an auxiliary embedding model;
calculating a second task loss by performing a transformation determination task or a transformation detection task based on the second embedding representation; and
updating an associated prompt encoder based on the second task loss.

7. The method of claim 6, wherein the auxiliary embedding model is configured to generate the second embedding representation by further receiving the first embedding representation.

8. The method of claim 7, wherein the auxiliary embedding model is configured to generate the second embedding representation by receiving only the transformed data sample and the first embedding representation.

9. The method of claim 6, wherein the transformation determination task or the transformation detection task is performed through a task module, and
the task module is updated based on the second task loss.

10. The method of claim 6, wherein the prompt encoder and the prompt are a first prompt encoder and a first prompt, respectively,
the second embedding representation is generated by inputting a second prompt associated with the transformed data sample to the auxiliary embedding model,
the second prompt is generated through a second prompt encoder, and
the associated prompt encoder includes the second prompt encoder.

11. The method according to claim 10, wherein the second prompt encoder and the first prompt encoder are configured to share at least some weight parameters.

12. The method of claim 6, wherein the auxiliary embedding model is a pretrained model, and
the updating the associated prompt encoder includes updating the associated prompt encoder in a state that the auxiliary embedding model is freezing.

13. The method of claim 6, wherein the data sample is an image sample, and
the generating the transformed data sample includes:
dividing the image sample into a plurality of patches; and
transforming at least a portion of the plurality of patches.

14. The method of claim 1, wherein the task loss and the embedding representation are a first task loss and a first embedding representation, respectively,
the data sample is an anchor sample or a transformed sample for the anchor sample, and
the method further comprising:
acquiring another data sample paired with the anchor sample, the another data sample being a positive sample or a negative sample for the anchor sample;
generating a transformed data sample for the another data sample;
generating a second embedding representation by inputting the first embedding representation and the transformed data sample to an auxiliary embedding model;
calculating a second task loss by performing a transformation determination task or a transformation detection task based on the second embedding representation; and
updating an associated prompt encoder based on the second task loss.

15. The method of claim 1, wherein the data sample and the embedding representation are a first data sample and a first embedding representation, respectively,
the method further comprising:
acquiring second data sample;
generating a prompt associated with the second data sample through the updated prompt encoder; and
generating a second embedding representation by inputting the prompt associated with the second data sample and the second data sample to the embedding model.

16. A data embedding system comprising:
a memory configured to store one or more instructions; and
one or more processors configured to execute the stored one or more instructions to perform:
acquiring a pretrained embedding model,
generating a prompt associated with a data sample through a prompt encoder, the prompt encoder being lighter than the embedding model;
generating an embedding representation of the data sample by inputting the prompt and the data sample to the embedding model;
calculating a task loss by performing a predefined task by using the embedding representation; and
updating the prompt encoder based on the task loss.

17. The data embedding system of claim 16, wherein the updating the prompt encoder includes updating the prompt encoder in a state of freezing the embedding model.

18. The data embedding system of claim 16, wherein the generated prompt includes a first prompt and a second prompt, and
the first prompt and the second prompt are input to different layers of the embedding model.

19. The data embedding system of claim 16, wherein the data sample is a text sample,
the embedding model is a model for further receiving a special token in addition to tokens included in the text sample, and
the generated prompt is reflected in an internal embedding representation of the embedding model associated with the special token.

20. A non-transitory computer-readable recording medium storing computer program executable by at least one processor to perform:
acquiring a pretrained embedding model;
generating a prompt associated with a data sample through a prompt encoder, the prompt encoder being lighter than the embedding model;
generating an embedding representation of the data sample by inputting the prompt and the data sample to the embedding model;
calculating a task loss by performing a predefined task by using the embedding representation; and
updating the prompt encoder based on the task loss.
